(19) United States
(12) Patent Application Publication
(10) Pub. No.: US 2025/0092254 A1
(43) Pub. Date: Mar. 20, 2025

(54) Thermoplastic Resin Composition and Molded Article Manufactured From Same

(71) Applicant: LOTTE CHEMICAL CORPORATION, Seoul (KR)

(72) Inventors: Semi KIM, Uiwang-si (KR); Kyoungju KIM, Uiwang-si (KR); Keehae KWON, Uiwang-si (KR); In-Chol KIM, Uiwang-si (KR); Jungeun PARK, Uiwang-si (KR)

(21) Appl. No.: 18/724,315

(22) PCT Filed: Dec. 23, 2022
(86) PCT No.: PCT/KR2022/021184

§ 371 Date: Jun. 26, 2024

(30) Foreign Application Priority Data
Dec. 29, 2021 (KR) 10-2021-0191621

(51) Int. Cl. C08L 69/00; C08K 3/08; C08K 3/32; C08K 3/34

(52) U.S. Cl. CPC C08L 69/00; C08K 3/08; C08K 3/32; C08K 3/34; C08K 2003/0812; C08K 2003/324; C08K 2003/343; C08K 2201/005; C08K 2201/014; C08L 2203/30; C08L 2205/025; C08L 2205/03

(57) ABSTRACT

Disclosed a thermoplastic resin composition, and a molded article manufactured therefrom, the thermoplastic resin composition including, based on 100 parts by weight of a base resin including (A) 50 to 90 wt % of a polycarbonate resin; and (B) 10 to 50 wt % of a polysiloxane-polycarbonate copolymer resin, (C) 0.1 to 2 parts by weight of an aluminum-based pigment, 0.01 to 0.1 parts by weight of a mica-based pigment, or a combination thereof; and (D) 0.05 to 0.5 parts by weight of sodium phosphate monobasic dihydrate.

### TECHNICAL FIELD

Thermoplastic resin compositions and molded articles manufactured therefrom are disclosed.

### BACKGROUND ART

The thermoplastic resins have a lower specific gravity than glass or metal and also, advantages of excellent moldability and impact resistance and the like. With the recent trend of lower cost, larger size, lighter electrical and electronic products, plastic products using the thermoplastic resins have rapidly replaced conventional glass or metal products and are more widely used from the electrical and electronic products to automobile parts.

Among the thermoplastic resins, polycarbonate (PC) resins have excellent impact resistance, heat resistance, strength, etc. and thus is variously applied to the electrical and electronic products and the automobile parts.

To automobile interior/exterior materials among them, various polycarbonate alloy resins are applied to supplement physical properties such as low temperature impact resistance, chemical resistance, and the like, while maintaining properties such as excellent impact resistance, heat resistance, strength, and the like of the polycarbonate resins.

In particular, as interests in automobile interior design are rapidly increasing, because development of interior materials with a metallic painting texture is required, and the polycarbonate resins with excellent transparency as well as excellent heat resistance, impact resistance, strength, etc. are expected to realize excellent metallic painting texture with a low cost, development of a polycarbonate resin composition with a metallic painting texture is in progress.

However, if metal particles are included in the polycarbonate resin to realize the metallic painting texture, there may be problems of deteriorating thermal stability of the polycarbonate resin by the metal particles and thus discoloring the polycarbonate resin or causing poor appearance such as a silver streak and the like and resultantly, deteriorating various physical properties such as heat resistance, impact resistance, and the like.

### DISCLOSURE

### Technical Problem

In order to solve the problems, the present invention provides a thermoplastic resin composition capable of realizing a metallic painting texture and a pearl painting texture as well as having excellent overall properties such as heat resistance, impact resistance, and the like and exhibiting excellent appearance and a molded article manufactured therefrom.

### Technical Solution

According to an embodiment, a thermoplastic resin composition includes, based on 100 parts by weight of a base resin including (A) 50 to 90 wt % of a polycarbonate resin; and (B) 10 to 50 wt % of a polysiloxane-polycarbonate copolymer resin, (C) 0.1 to 2 parts by weight of an aluminum-based pigment, 0.01 to 0.1 parts by weight of a mica-based pigment, or a combination thereof; and (D) 0.05 to 0.5 parts by weight of sodium phosphate monobasic dihydrate.

The (A) polycarbonate resin may have a melt flow index of 10 to 70 g/10 min measured at 300° C. and 1.2 kg load according to ASTM D1238.

The (A) polycarbonate resin may have a weight average molecular weight of 10,000 to 200,000 g/mol.

The (B) polysiloxane-polycarbonate copolymer resin may include 50 to 95 wt % of a carbonate block and 5 to 50 wt % of a siloxane block.

The aluminum-based pigment may have an average particle diameter (D50) of 10 to 100 μm.

The mica-based pigment may have an average particle diameter (D50) of 1 to 20 μm.

The thermoplastic resin composition may further include at least one additive selected from flame retardants, nucleating agents, coupling agents, glass fibers, plasticizers, lubricants, mineral fillers, antibacterial agents, mold release agents, heat stabilizers, antioxidants, ultraviolet stabilizers, and antistatic agents.

Meanwhile, a molded article using the thermoplastic resin composition according to an embodiment may be provided.

The molded article may have an Izod impact strength of 7 kgf·cm/cm or more, measured according to ASTM D256 standard at ¼ inch thickness.

The molded article may have a heat distortion temperature of 124° C. or higher as measured according to the ASTM D648 standard under a load condition of 1.82 MPa.

### Advantageous Effects

The thermoplastic resin composition according to an embodiment and the molded article manufactured therefrom have excellent physical properties such as heat resistance and impact resistance, can achieve an excellent metallic painting texture or pearl painting texture, and have an excellent appearance.

### DESCRIPTION OF THE DRAWINGS

FIG. 1 shows evaluation criteria for comparing the appearance of molded articles obtained by injection molding thermoplastic resin compositions of Examples and Comparative Examples.

FIG. 2 shows evaluation criteria for comparing the appearance of molded articles obtained by injection molding the thermoplastic resin compositions of Examples and Comparative Examples after remaining in the injection molding machine cylinder.

### MODE FOR INVENTION

Hereinafter, embodiments of the present invention are described in detail. However, these embodiments are exemplary, the present invention is not limited thereto and the present invention is defined by the scope of claims.

In the present specification, unless otherwise mentioned, “copolymerization” refers to a block copolymerization, a random copolymerization, or a graft-copolymerization and “copolymer” refers to a block copolymer, a random copolymer, or a graft copolymer.

In the present specification, unless otherwise mentioned, the average particle diameter of the rubbery polymer refers to a volume average diameter, and means a Z-average particle diameter measured using a dynamic light scattering analysis equipment.

In the present specification, unless otherwise mentioned, the average particle diameter of the pigment means an average particle diameter (D50) measured with a laser particle size analyzer (Malvern Panalytical, Mastersizer 3000).

In the present specification, unless otherwise mentioned, a weight average molecular weight is measured using gel permeation chromatography (GPC) with a 1200 series made by Agilent Technologies Inc. after dissolving the powder sample in an appropriate solvent (the standard sample is Shodex polystyrene).

According to an embodiment, a thermoplastic resin composition includes, based on 100 parts by weight of a base resin including (A) 50 to 90 wt % of a polycarbonate resin; and (B) 10 to 50 wt % of a polysiloxane-polycarbonate copolymer resin, (C) 0.1 to 2 parts by weight of an aluminum-based pigment, 0.01 to 0.1 parts by weight of a mica-based pigment, or a combination thereof; and (D) 0.05 to 0.5 parts by weight of sodium phosphate monobasic dihydrate.

Hereinafter, each component of the thermoplastic resin composition is described in detail.

### (A) Polycarbonate Resin

The (A) polycarbonate (PC) resin is a polyester having a carbonate bond, but has no particular limit in its type, and may include any polycarbonate resin usable in the resin composition field.

For example, it may be prepared by reacting a diphenol compound represented by Chemical Formula 1 with a compound selected from phosgene, halogen acid esters, carbonate esters, and a combination thereof.

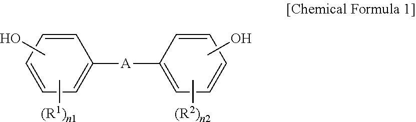

In Chemical Formula 1,

A is a single bond, a substituted or unsubstituted C1 to C30 alkylene group, a substituted or unsubstituted C2 to C5 alkenylene group, a substituted or unsubstituted C2 to C5 alkylidene group, a substituted or unsubstituted C1 to C30 haloalkylene group, a substituted or unsubstituted C5 to C6 cycloalkylene group, a substituted or unsubstituted C5 to C6 cycloalkenylene group, a substituted or unsubstituted C5 to C10 cycloalkylidene group, a substituted or unsubstituted C6 to C30 arylene group, a substituted or unsubstituted C1 to C20 alkoxylene group, a halogenic acid ester group, a carbonate ester group, a linking group selected from C═O, S, and SO₂, R¹ and R² are each independently a substituted or unsubstituted C1 to C30 alkyl group or a substituted or unsubstituted C6 to C30 aryl group, and n1 and n2 are each independently an integer ranging from 0 to 4.

Two or more types of the diphenols represented by Chemical Formula 1 may be combined to constitute a repeating unit of the polycarbonate resin.

Specific examples of the diphenols may include hydroquinone, resorcinol, 4,4′-dihydroxydiphenyl, 2,2-bis(4-hydroxyphenyl) propane (also referred to as “bisphenol-A”), 2,4-bis(4-hydroxyphenyl)-2-methylbutane, bis(4-hydroxyphenyl) methane, 1,1-bis(4-hydroxyphenyl)cyclohexane, 2,2-bis(3-chloro-4-hydroxyphenyl) propane, 2,2-bis(3-methyl-4-hydroxyphenyl) propane, 2,2-bis(3,5-dimethyl-4-hydroxyphenyl) propane, 2,2-bis(3,5-dichloro-4-hydroxyphenyl) propane, 2,2-bis(3,5-dibromo-4-hydroxyphenyl) propane, bis(4-hydroxyphenyl) sulfoxide, bis(4-hydroxyphenyl) ketone, bis(4-hydroxyphenyl) ether, and the like. Among the diphenols, 2,2-bis(4-hydroxyphenyl) propane, 2,2-bis(3-methyl-4-hydroxyphenyl) propane, 2,2-bis(3,5-dimethyl-4-hydroxyphenyl) propane, 2,2-bis(3,5-dichloro-4-hydroxyphenyl) propane, or 1,1-bis(4-hydroxyphenyl)cyclohexane may be desirably used. 2,2-bis(4-hydroxyphenyl) propane may be more desirably used.

The (A) polycarbonate resin may be a mixture of copolymers obtained using two or more types of diphenols. Additionally, the polycarbonate resin may be linear polycarbonate resin, branched polycarbonate resin, polyester carbonate copolymer resin, and the like.

A specific example of the linear polycarbonate resin may be a bisphenol-A polycarbonate resin. Specific examples of the branched polycarbonate resin may be a resin prepared by reacting a multi-functional aromatic compound such as trimellitic anhydride, trimellitic acid, and the like with diphenols and a carbonate. The polyester carbonate copolymer resin may be prepared by reacting a difunctional carboxylic acid with diphenols and carbonate, and the carbonate used here may be a diaryl carbonate such as diphenyl carbonate or ethylene carbonate.

The (A) polycarbonate resin may have a weight average molecular weight of 10,000 to 200,000 g/mol, for example 14,000 to 50,000 g/mol. When the weight average molecular weight of the polycarbonate resin is within the above range, excellent impact resistance and fluidity can be obtained.

The (A) polycarbonate resin may be included in an amount of 50 to 90 wt %, for example 60 to 90 wt %, based on 100 wt % of the base resin. Within the above weight range, the thermoplastic resin composition can exhibit excellent appearance and mechanical strength.

The (A) polycarbonate resin may have a melt flow index of 10 to 70 g/10 min, for example 15 to 65 g/10 min, as measured at 300° C. and 1.2 kg load according to ASTM D1238. When a polycarbonate resin having a melt flow index in the above range is used, a molded article manufactured therefrom can exhibit excellent moldability and excellent impact resistance.

Meanwhile, the (A) polycarbonate resin can be used by mixing two or more polycarbonate resins with different weight average molecular weights or melt flow indices. By using a mixture of polycarbonate resins of different weight average molecular weights or melt flow indices, it is easy to adjust the thermoplastic resin composition to have the desired fluidity.

### (B) Polysiloxane-Polycarbonate Copolymer Resin

The (B) polysiloxane-polycarbonate copolymer (Si—PC) resin can be included in the base resin together with the (A) polycarbonate resin to improve the impact resistance of a thermoplastic resin composition including the same.

The (B) polysiloxane-polycarbonate copolymer resin may include a polycarbonate block and a polysiloxane block.

The polycarbonate block may include a structural unit derived from the aforementioned (A) polycarbonate resin.

The polysiloxane block may include a structural unit represented by Chemical Formula 2.

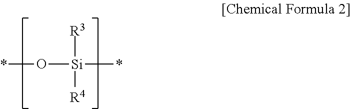

In Chemical Formula 2, R³ and R⁴ are the same or different, and may be a hydrogen atom, a substituted or unsubstituted C1 to C20 alkyl group, a substituted or unsubstituted C2 to C20 alkenyl group, a substituted or unsubstituted C2 to C20 alkynyl group, a substituted or unsubstituted C1 to C20 alkoxy group, a substituted or unsubstituted C3 to C30 cycloalkyl group, a substituted or unsubstituted C3 to C30 cycloalkenyl group, a substituted or unsubstituted C3 to C30 cycloalkynyl group, a substituted or unsubstituted C6 to C30 aryl group, a substituted or unsubstituted C6 to C30 aryloxy group, a substituted or unsubstituted C6 to C30 aryl group, or NRR′ (wherein R and R′ are the same or different, and a hydrogen atom, or a substituted or unsubstituted C1 to C20 alkyl group).

The structural unit represented by Chemical Formula 2 may exist in the polysiloxane-polycarbonate copolymer in a range of 2 to 10,000 units, for example 2 to 1,000 units, for example 10 to 100 units, for example 25 to 80 units. By including the structural unit represented by Chemical Formula 2 in the above range, the thermoplastic resin composition including it may have excellent impact resistance and may be easily extruded.

The (B) polysiloxane-polycarbonate copolymer resin may include 50 to 95 wt % of a carbonate block and 5 to 50 wt % of a siloxane block, for example 80 to 95 wt % of a carbonate block and 5 to 20 wt % of a siloxane block. Within the above range, a thermoplastic resin composition including the same may have excellent impact resistance and transparency.

The (B) polysiloxane-polycarbonate copolymer resin may have a weight average molecular weight of 10,000 to 100,000 g/mol, for example 10,000 to 50,000 g/mol, for example 15,000 to 30,000 g/mol. Within the above range, a thermoplastic resin composition including the same may have excellent impact resistance.

The (B) polysiloxane-polycarbonate copolymer resin may be included in an amount of 10 to 50 wt %, for example 10 to 40 wt %, based on 100 wt % of the base resin. Within the above range, the physical property balance of impact resistance, heat resistance, and processability of the thermoplastic resin composition containing it may be excellent.

### (C) Aluminum-Based Pigment and Mica-Based Pigment

The (C) aluminum-based pigment (C1) and the mica-based pigment (C2) may be used individually or together to impart a metallic painting texture and/or a pearl painting texture to the thermoplastic resin composition.

The (C1) aluminum-based pigment may be used by mixing with other metal materials to provide a desired metallic painting texture. Here, the other metal materials may include sodium (Na), iron (Fe), copper (Cu), zinc (Zn), titanium (Ti), nickel (Ni), tin (Sn), antimony (Sb), and magnesium (Mg), vanadium (V), chromium (Cr), or zirconium (Zr) may be included, but are not limited thereto.

The (C2) mica-based pigment may be used by coating natural mica and/or synthetic mica with titanium dioxide, iron oxide, and/or tin oxide to provide the desired pearl painting texture.

The (C1) aluminum-based pigment may have an average particle diameter (D50) of 10 to 100 μm and the (C2) mica-based pigment may have an average particle diameter (D50) of 1 to 20 μm. The average particle diameter (D50) of the (C1) aluminum-based pigment may be, for example 10 to 90 μm, for example 10 to 80 μm, for example 10 to 70 μm, for example 20 to 80 μm, for example 20 to 70 μm, for example 30 to 70 μm. The average particle diameter of the (C2) mica-based pigment may be, for example 1 to 15 μm, for example 1 to 12 μm, for example 2 to 15 μm, for example 2 to 12 μm. Within the above range, a thermoplastic resin composition including the same may exhibit excellent metallic painting texture and/or pearl painting texture.

The (C1) aluminum-based pigment may be included in an amount of 0.1 to 2 parts by weight, for example 0.1 to 1.5 parts by weight, for example 0.1 to 1 part by weight, for example 0.1 to 0.5 parts by weight, for example 0.5 to 1 part by weight, for example 1.5 to 2 parts by weight based on 100 parts by weight of the base resin. Within the above range, the thermoplastic resin composition and molded articles manufactured therefrom can exhibit excellent metallic painting texture and maintain excellent impact resistance.

The (C2) mica-based pigment may be included in an amount of 0.01 to 0.1 parts by weight, for example 0.05 to 0.1 parts by weight, based on 100 parts by weight of the base resin. Within the above range, the thermoplastic resin composition and molded articles manufactured therefrom can maintain excellent impact resistance while exhibiting pearl painting texture.

### (D) Sodium Phosphate Monobasic Dihydrate

The (D) sodium phosphate monobasic dihydrate provides excellent thermal stability of the thermoplastic resin composition and molded articles manufactured therefrom.

In general, when metal pigments or pearl pigments are applied to polycarbonate resin to create a metallic painting texture or pearl painting texture, there are problems with appearance defects such as discoloration or silver streaks due to decreased thermal stability, and deterioration of all physical properties such as heat resistance and impact resistance. In order to prevent this, heat stabilizers such as phosphorus-based stabilizers and phenol-based stabilizers are applied.

As a result of repeated research, the present inventors have found that, among heat stabilizers, when sodium phosphate monobasic dihydrate is applied to a thermoplastic resin composition including the above components (A) to (C), it has been discovered that while maintaining all physical properties such as heat resistance, impact resistance, and fluidity of the thermoplastic resin composition and the excellent metallic painting texture or pearl painting texture, appearance defects such as discoloration and silver streak may be particularly improved.

The (D) sodium phosphate monobasic dihydrate may be included in an amount of 0.05 to 0.5 parts by weight, for example 0.1 to 0.5 parts by weight, for example 0.1 to 0.3 parts by weight, for example 0.1 to 0.2 parts by weight, based on 100 parts by weight of the base resin.

### (E) Other Additives

In addition to the components (A) to (D), the thermoplastic resin composition according to an embodiment may further include one or more necessary additives in order to balance each physical property under conditions of maintaining excellent impact resistance, heat resistance, fluidity, thermal stability, and appearance, or depending on the final use of the thermoplastic resin composition.

Specifically, the additives may include at least one additive selected from flame retardants, nucleating agents, coupling agents, glass fibers, plasticizers, lubricants, mineral fillers, antibacterial agents, mold release agents, heat stabilizers, antioxidants, ultraviolet stabilizers, and antistatic agents.

These additives may be appropriately included within a range that does not impair the physical properties of the thermoplastic resin composition, and may specifically be included in an amount of 20 parts by weight or less based on 100 parts by weight of the base resin, but are not limited thereto.

The thermoplastic resin composition according to the present invention can be prepared by a known method for preparing a thermoplastic resin composition.

For example, the thermoplastic resin composition according to the present invention can be prepared in a form of pellets by mixing the components of the present invention and other additives and then melting and kneading them in an extruder.

A molded article according to an embodiment of the present invention may be manufactured from the aforementioned thermoplastic resin composition.

The molded article may have an Izod impact strength of 7 kgf·cm/cm or more, measured according to ASTM D256 standard at ¼ inch thickness.

The molded article may have a heat distortion temperature of 124° C. or higher as measured according to the ASTM D648 standard under a load condition of 1.82 MPa.

Hereinafter, the present invention is illustrated in more detail with reference to examples and comparative examples. However, the following examples and comparative examples are provided for the purpose of descriptions and the present invention is not limited thereto.

Hereinafter, preferred embodiments of the present invention will be described. However, the following example is only a preferred example of the present invention, and the present invention is not limited by the following example.

### EXAMPLES 1 TO 4 AND COMPARATIVE EXAMPLES 1 TO 4

The thermoplastic resin compositions according to Examples 1 to 4 and Comparative Examples 1 to 4 were respectively prepared according to each component content ratio shown in Table 1.

The components listed in Table 1 were dry-mixed and quantitatively continuously fed into a feed section of a twin-screw extruder (L/D=36, a diameter=45 mm) to melt/knead. Herein, the twin-screw extruder was set at a barrel temperature of about 250° C. Subsequently, each of the thermoplastic resin compositions was pelletized through the twin-screw extruder and dried at about 100° C. for about 2 hours and then, injection-molded by using a 6 oz injection molding machine set at a cylinder temperature of about 280° C. and a mold temperature of about 60° C. to obtain a specimen for measuring physical properties and a specimen (100 mm×100 mm×3.2 mm) for verifying its appearance. Subsequently, a specimen (50 mm×200 mm×2 mm) for verifying appearance of a molded article was injection-molded after allowing the thermoplastic resin composition in the injection molding machine cylinder for 7 minutes by using a 3 oz injection molding machine set at a cylinder temperature of about 300° C. and a mold temperature of about 60° C.

In Table 1, (A-1), (A-2), and (B) represent wt % of each component based on 100 wt % of a base resin, and (C) and (D) represent parts by weight thereof based on 100 parts by weight of the base resin ((A-1)+ (A-2)+ (B)).

TABLE 1

| | | | | | Comp. | Comp. | Comp. | Comp. |
|---|---|---|---|---|---|---|---|---|
| | Ex. 1 | Ex. 2 | Ex. 3 | Ex. 4 | Ex. 1 | Ex. 2 | Ex. 3 | Ex. 4 |
| (A-1) | 45 | 45 | 45 | 45 | 45 | 45 | 45 | 45 |
| (A-2) | 40 | 40 | 40 | 40 | 40 | 40 | 40 | 40 |
| (B) | 15 | 15 | 15 | 15 | 15 | 15 | 15 | 15 |
| (C1) | 1.0 | 1.5 | 2.0 | — | 1.5 | 3.0 | — | 1.0 |
| (C2) | — | — | — | 0.1 | — | — | 1.0 | — |
| (D) | 0.1 | 0.1 | 0.1 | 0.1 | — | 0.1 | 0.1 | — |
| (D′) | — | — | — | — | — | — | — | 0.1 |

Each component listed in Table 1 was described as follows.

### (A-1) Polycarbonate Resin

A polycarbonate resin (Lotte Chemical Corp.) with a melt flow index of about 19 g/10 min, which was measured at 300° C. under a load of 1.2 kg according to ASTM D1238, was used.

### (A-2) Polycarbonate Resin

A polycarbonate resin (Lotte Chemical Corp.) with a melt flow index of about 62 g/10 min, which was measured at 300° C. under a load of 1.2 kg according to ASTM D1238, was used.

### (B) Polysiloxane-Polycarbonate Copolymer Resin

A polysiloxane-polycarbonate copolymer resin including about 92 wt % of a carbonate block and about 8 wt % of a siloxane block (ST6-3022PJ, Samyang Corp.) was used.

### (C1) Aluminum-Based Pigment

SM 3S15 made by Youngbio Chemical Co., Ltd. was used.

### (C2) Mica-Based Pigment

Silk White N-801F made by CQV Co., Ltd. was used.

### (D) Sodium Phosphate Monobasic Dihydrate

Sodium phosphate monobasic dihydrate made by Youngjin Chemical Co., Ltd. was used.

### (D′) Stearyl Phosphate

AX-71 made by Adeka Corp. was used.

### EXPERIMENTAL EXAMPLES

Experiment results are shown in Table 2.

(1) Impact resistance (unit: kgf·cm/cm): Notched Izod impact strength was measured for ¼ inch-thick specimens according to ASTM D256.

(2) Fluidity (unit: g/10 min): Melt flow index (MI) was measured at 300° C. and 1.2 kg load according to ASTM D1238.

(3) Heat resistance (unit: ° C.): A heat deflection temperature (HDT) was measured under a load of 1.82 MPa according to ASTM D648.

(4) Appearance

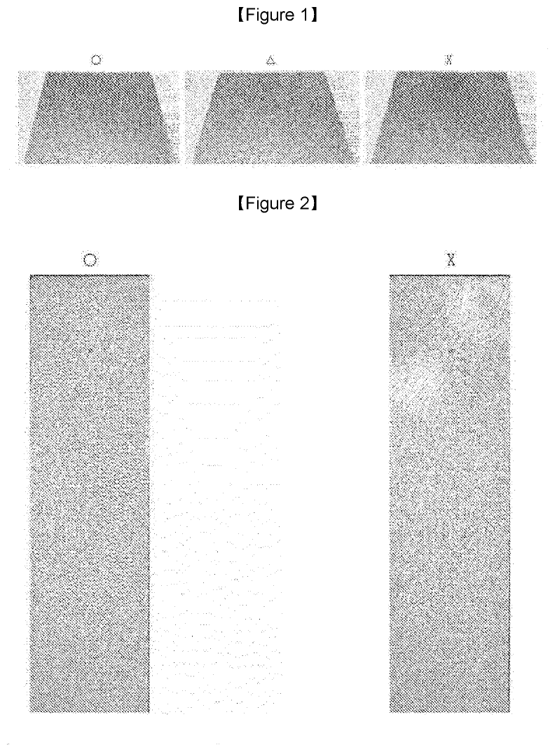

A specimen for evaluating appearance (100 mm×100 mm×3.2 mm), a thermoplastic resin composition pellet injection-molded at a cylinder temperature of about 280° C. and a mold temperature of about 60° C., was examined with naked eyes and then, evaluated by giving grades of ∘, Δ, x according to evaluation criteria of FIG. 1.

(5) Appearance after Residence

A thermoplastic resin composition pellet in a molten state was allowed to stay in an injection molding machine cylinder for 7 minutes at a cylinder temperature of about 300° C. and a mold temperature of about 60° C. and then, injected therefrom to obtain a specimen (50 mm×200 mm×2 mm) for evaluating appearance, which was examined with naked eyes to give a grade of ∘ or x according to evaluation criteria of FIG. 2.

TABLE 2

| | | | | | Comp. | Comp. | Comp. | Comp. |
|---|---|---|---|---|---|---|---|---|
| | Ex. 1 | Ex. 2 | Ex. 3 | Ex. 4 | Ex. 1 | Ex. 2 | Ex. 3 | Ex. 4 |
| Izod impact strength | 8.4 | 7.9 | 7.6 | 12.0 | 16.0 | 7.2 | 9.0 | 7.8 |
| MI | 29 | 30 | 30 | 31 | 33 | 32 | 37 | 37 |
| HDT | 126.0 | 126.2 | 126.5 | 124.5 | 124.9 | 126.8 | 122.0 | 125.3 |
| Appearance | ◯ | ◯ | ◯ | ◯ | X | Δ | Δ | ◯ |
| Appearance after | ◯ | ◯ | ◯ | ◯ | X | X | X | X |
| residence | | | | | | | | |

Referring to Tables 1 and 2, a thermoplastic resin composition may be prepared to include a polycarbonate resin, a polysiloxane-polycarbonate copolymer resin, an aluminum-based pigment, and/or a mica-based pigment, and a sodium phosphate monobasic dihydrate in each optimal amount, providing a thermoplastic resin composition with excellent appearance as well as excellent impact resistance, heat resistance, and fluidity and a molded article manufactured therefrom.

In particular, Comparative Example 4 used the same components as in Example 1 except that stearyl phosphate was used as a heat stabilizer but exhibited inferior appearance after retention to that of Example 1.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

1. A thermoplastic resin composition, comprising
based on 100 parts by weight of a base resin including
(A) 50 to 90 wt % of a polycarbonate resin; and
(B) 10 to 50 wt % of a polysiloxane-polycarbonate copolymer resin,
(C) 0.1 to 2 parts by weight of an aluminum-based pigment, 0.01 to 0.1 parts by weight of a mica-based pigment, or a combination thereof; and
(D) 0.05 to 0.5 parts by weight of sodium phosphate monobasic dihydrate.

2. The thermoplastic resin composition of claim 1, wherein
the (A) polycarbonate resin has a melt flow index of 10 to 70 g/10 min measured at 300° C. and 1.2 kg load according to ASTM D1238.

3. The thermoplastic resin composition of claim 1, wherein
the (A) polycarbonate resin has a weight average molecular weight of 10,000 to 200,000 g/mol.

4. The thermoplastic resin composition of claim 1, wherein
the (B) polysiloxane-polycarbonate copolymer resin includes 50 to 95 wt % of a carbonate block and 5 to 50 wt % of a siloxane block.

5. The thermoplastic resin composition of claim 1, wherein
the aluminum-based pigment has an average particle diameter (D50) of 10 to 100 μm.

6. The thermoplastic resin composition of claim 1, wherein
the mica-based pigment has an average particle diameter (D50) of 1 to 20 μm.

7. The thermoplastic resin composition of claim 1, wherein
the thermoplastic resin composition further includes at least one additive selected from flame retardants, nucleating agents, coupling agents, glass fibers, plasticizers, lubricants, mineral fillers, antibacterial agents, mold release agents, heat stabilizers, antioxidants, ultraviolet stabilizers, and antistatic agents.

8. A molded article using the thermoplastic resin composition of claim 1.

9. The molded article of claim 8, wherein
the molded article has an Izod impact strength of 7 kgf cm/cm or more, measured according to ASTM D256 standard at ¼ inch thickness.

10. The molded article of claim 8, wherein
the molded article has a heat distortion temperature of 124° C. or higher as measured according to the ASTM D648 standard under a load condition of 1.82 MPa.
